(19) United States
(12) Patent Application Publication
(10) Pub. No.: US 2011/0007721 A1
(43) Pub. Date: Jan. 13, 2011

(54) METHOD FOR DIRECTIONAL ASSOCIATION

(75) Inventors: Mohammad Hossein Taghavi Nasrabadi, San Diego, CA (US); Hemanth Sampath, San Diego, CA (US); Santosh P. Abraham, San Diego, CA (US); Sameer Vermani, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/558,979

(22) Filed: Sep. 14, 2009

Related U.S. Application Data
(60) Provisional application No. 61/224,833, filed on Jul. 10, 2009.

(51) Int. Cl. H04W 84/02

(52) U.S. Cl. 370/338

(57) ABSTRACT

A method, an apparatus, and a computer program product operable in a wireless communication system are provided in which an access probe is generated for transmission to a wireless node. A first signal is generated for transmission to the wireless node. The first signal includes information corresponding to a first preferred beam pattern from the wireless node to the apparatus. A second signal is received from the wireless node including information corresponding to a second preferred beam pattern from the apparatus to the wireless node. The second preferred beam pattern is determined based on the access probe. The apparatus communicates with the wireless node using at least one of the first preferred beam pattern or the second preferred beam pattern.

### CROSS-REFERENCE TO RELATED APPLICATION(S)

Pursuant to 35 U.S.C. §119(e), this application claims the benefit of U.S. Provisional Application Ser. No. 61/224,833 filed on Jul. 10, 2009, the contents of which are hereby incorporated by reference herein in their entirety.

### BACKGROUND

1. Field

The following description relates generally to communication systems, and more particularly to methods for directional association.

2. Background

In order to address the issue of increasing bandwidth requirements that are demanded for wireless communications systems, different technologies are being developed to allow multiple wireless nodes terminals to communicate with a single access point by sharing the channel resources while achieving high data throughputs. These technologies have been adopted in several emerging wireless communications standards such as the Institute of Electrical Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters). One example includes IEEE 802.11ad to support 60 GHz operation, which is sometimes referred as “Extremely High Throughput.”

Various protocols exist for high throughput systems. One example is the IEEE 802.15.3c MAC protocol for wireless personal area networks (PAN). The 802.15.3c MAC protocol attempts to use directional CSMA/CA based contention Access and REQ protocol. Unfortunately, 60 GHz transmission is highly directional, which exacerbates the hidden node problem and significantly increases the probability of collision.

### SUMMARY

In an aspect of the disclosure, an apparatus for wireless communication includes a processing system. The processing system is configured to generate an access probe for transmission to a wireless node. The processing system is further configured to generate a first signal for transmission to the wireless node. The first signal includes information corresponding to a first preferred beam pattern from the wireless node to the apparatus. The processing system is further configured to receive a second signal from the wireless node including information corresponding to a second preferred beam pattern from the apparatus to the wireless node. The second preferred beam pattern is determined based on the access probe. The processing system is further configured to communicate with the wireless node using at least one of the first preferred beam pattern or the second preferred beam pattern.

In an aspect of the disclosure, an apparatus for wireless communication includes a processing system. The processing system is configured to receive a first signal from each of at least one wireless node. Each first signal includes information corresponding to a first preferred beam pattern from the apparatus to the corresponding at least one wireless node. The processing system is further configured to generate a second signal for transmission to each of the at least one wireless node. Each second signal includes information corresponding to a second preferred beam pattern from the corresponding at least one wireless node to the apparatus. The processing system is further configured to communicate with each of the at least one wireless node using at least one of the first preferred beam pattern or the second preferred beam pattern corresponding to said each of the at least one wireless node.

In an aspect of the disclosure, a method for wireless communication is provided in which an access probe is generated for transmission to a wireless node. A first signal is generated for transmission to the wireless node. The first signal includes information corresponding to a first preferred beam pattern from the wireless node to an apparatus. A second signal is received from the wireless node including information corresponding to a second preferred beam pattern from the apparatus to the wireless node. The second preferred beam pattern is determined based on the access probe. The method further includes communicating with the wireless node using at least one of the first preferred beam pattern or the second preferred beam pattern.

In an aspect of the disclosure, a method for wireless communication is provided in which a first signal is received from each of at least one wireless node. Each first signal includes information corresponding to a first preferred beam pattern from an apparatus to the corresponding at least one wireless node. A second signal is generated for transmission to each of the at least one wireless node. Each second signal includes information corresponding to a second preferred beam pattern from the corresponding at least one wireless node to the apparatus. The method further includes communicating with each of the at least one wireless node using at least one of the first preferred beam pattern or the second preferred beam pattern corresponding to said each of the at least one wireless node.

In an aspect of the disclosure, an apparatus for wireless communication includes means for generating an access probe for transmission to a wireless node; means for generating a first signal for transmission to the wireless node, the first signal including information corresponding to a first preferred beam pattern from the wireless node to the apparatus;
means for receiving a second signal from the wireless node including information corresponding to a second preferred beam pattern from the apparatus to the wireless node, the second preferred beam pattern being determined based on the access probe; and means for communicating with the wireless node using at least one of the first preferred beam pattern or the second preferred beam pattern.

In an aspect of the disclosure, an apparatus for wireless communication includes means for receiving a first signal from each of at least one wireless node, each first signal including information corresponding to a first preferred beam pattern from the apparatus to the corresponding at least one wireless node; means for generating a second signal for transmission to each of the at least one wireless node, each second signal including information corresponding to a second preferred beam pattern from the corresponding at least one wireless node to the apparatus; and means for communicating with each of the at least one wireless node using at least one of the first preferred beam pattern or the second preferred beam pattern corresponding to said each of the at least one wireless node.

In an aspect of the disclosure, a computer-program product for communication includes a machine-readable medium including instructions executable to generate an access probe for transmission to a wireless node. The machine-readable medium further includes instructions executable to generate a first signal for transmission to the wireless node. The first signal includes information corresponding to a first preferred beam pattern from the wireless node to the apparatus. The machine-readable medium further includes instructions executable to receive a second signal from the wireless node including information corresponding to a second preferred beam pattern from the apparatus to the wireless node. The second preferred beam pattern is determined based on the access probe. The machine-readable medium further includes instructions executable to communicate with the wireless node using at least one of the first preferred beam pattern or the second preferred beam pattern.

In an aspect of the disclosure, a computer-program product for communication includes a machine-readable medium including instructions executable to receive a first signal from each of at least one wireless node. Each first signal includes information corresponding to a first preferred beam pattern from the apparatus to the corresponding at least one wireless node. The machine-readable medium further includes instructions executable to generate a second signal for transmission to each of the at least one wireless node. Each second signal includes information corresponding to a second preferred beam pattern from the corresponding at least one wireless node to the apparatus. The machine-readable medium further includes instructions executable to communicate with each of the at least one wireless node using at least one of the first preferred beam pattern or the second preferred beam pattern corresponding to said each of the at least one wireless node.

In an aspect of the disclosure, a station for wireless communication includes a processing system and a wireless interface. The processing system is configured to generate an access probe for transmission to a wireless node; generate a first signal for transmission to the wireless node, the first signal including information corresponding to a first preferred beam pattern from the wireless node to the station; receive a second signal from the wireless node including information corresponding to a second preferred beam pattern from the station to the wireless node, the second preferred beam pattern being determined based on the access probe; and communicate with the wireless node using at least one of the first preferred beam pattern or the second preferred beam pattern. The wireless interface has one or more antennas configured to support the first and second preferred beam patterns, and a user interface coupled to the processing system.

In an aspect of the disclosure, an access point includes a processing system and a wireless interface. The processing system is configured to receive a first signal from each of at least one wireless node, each first signal including information corresponding to a first preferred beam pattern from the access point to the corresponding at least one wireless node; generate a second signal for transmission to each of the at least one wireless node, each second signal including information corresponding to a second preferred beam pattern from the corresponding at least one wireless node to the access point; and communicate with each of the at least one wireless node using at least one of the first preferred beam pattern or the second preferred beam pattern corresponding to said each of the at least one wireless node. The wireless interface has one or more antennas configured to support the first and second preferred beam patterns.

### BRIEF DESCRIPTION OF DRAWINGS

FIG. 1 is a conceptual block diagram illustrating the hardware configuration for an exemplary apparatus.

FIG. 2 is a flow diagram illustrating an example of a timeline of an access process.

FIG. 3 is a conceptual block diagram illustrating the functionality of an exemplary apparatus.

FIG. 4 is a conceptual block diagram illustrating the functionality of another exemplary apparatus.

### DETAILED DESCRIPTION

Various aspects of the novel systems, apparatus and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that that the scope of disclosure is intended to cover any aspect of the novel systems, apparatus and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Several aspects of a wireless communications system will now be presented. The wireless communications system may support any number of apparatuses. In this example, each apparatus is implemented as a wireless node. A wireless node may be an access point (AP) or a station (STA).

The wireless communications system may be configured to support APs and STAs employing Multiple-Input and Multiple-Output (MIMO) technology supporting any suitable wireless technology, such as Orthogonal Frequency Division Multiplexing (OFDM). An OFDM system may implement IEEE 802.11, or some other air interface standard. Other suitable wireless technologies include, by way of example, Code Division Multiple Access (CDMA), Time Division Multiple Access (TDMA), or any other suitable wireless technology, or any combination of suitable wireless technologies. A CDMA system may implement IS-2000, IS-95, IS-856, Wideband-CDMA (WCDMA), or some other suitable air interface standard. A TDMA system may implement Global System for Mobile Communications (GSM) or some other suitable air interface standard. As those skilled in the art will readily appreciate, the various aspects of this disclosure are not limited to any particular wireless technology and/or air interface standard. The various concepts presented throughout this disclosure may also be extended to short range radio technology, such as Ultra-Wide Band (UWB), or some other short range air interface standard such as Bluetooth. The actual wireless technology and air interface standard employed for any particular communications system will depend on the specific application and the overall design constraints imposed on the system. The various concepts presented throughout this disclosure are equally applicable to a wireless communications system employing other wireless technologies and/or air interface standards.

The wireless communications system may support any number of APs distributed throughout a geographic region to provide coverage for STAs. An AP is generally a fixed terminal that provides backhaul services to STAs in the geographic region of coverage. However, the AP may be mobile in some applications. A STA, which may be fixed or mobile, utilizes the backhaul services of an AP or engages in peer-to-peer communications with other STAs. Examples of STAs include a mobile telephone, laptop computer, a personal digital assistant (PDA), a mobile digital audio player, a mobile game console, a digital camera, a digital camcorder, a mobile audio device, a mobile video device, a mobile multimedia device, or any other suitable device capable of supporting wireless communications.

An AP or STA may be referred to by those skilled in the art by different nomenclature. By way of example, an AP may be referred to as a base station, a base transceiver station, a wireless device, a terminal, a node, or some other suitable terminology. Similarly, a STA may be referred to as a user terminal, a mobile station, a subscriber station, a wireless device, a terminal, an access terminal, a node, or some other suitable terminology. The various concepts described throughout this disclosure are intended to apply to all suitable apparatuses regardless of their specific nomenclature.

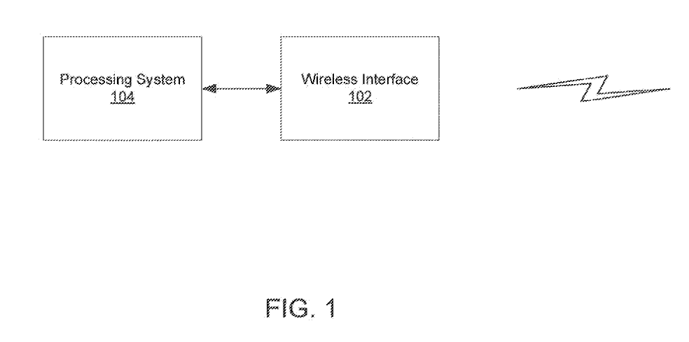

Various aspects of an apparatus will now be presented with reference to FIG. 1. FIG. 1 is a conceptual block diagram illustrating a hardware configuration for an apparatus. The apparatus 100 may include a wireless interface 102 and a processing system 104.

The wireless interface 102 may include a transceiver having a transmitter and receiver function to support two-way communications over the wireless medium. Alternatively, the wireless interface 102 may be configured as a transmitter or receiver to support one-way communications. In the detailed description that follows, a wireless interface may be described as a transmitter or a receiver to illustrate a particular aspect of the invention. Such a reference does not imply that the wireless interface is incapable of performing both transmit and receive operations.

The wireless interface 102 may support different air interface protocols. By way of example, the wireless interface 102 may include a 60 GHz HF radio to support IEEE 802.11 ad (Extremely High Throughput), or some other suitable air interface protocol. The wireless interface 102 may also be configured to implement the physical layer by modulating wireless signals and performing other radio frequency (RF) front end processing. Alternatively, the physical layer processing function may be performed by the processing system 104.

The wireless interface 102 is shown as a separate entity. However, as those skilled in the art will readily appreciate, the wireless interface 102, or any portion thereof, may be integrated into the processing system 104, or distributed across multiple entities within the apparatus 100.

The processing system 104 may be implemented with one or more processors. The one or more processors may be implemented with any combination of general-purpose microprocessors, microcontrollers, a Digital Signal Processors (DSP), Field Programmable Gate Arrays (FPGA), Programmable Logic Devices (PLD), controllers, state machines, gated logic, discrete hardware components, or any other suitable entities that can perform calculations or other manipulations of information.

The processing system 104 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 102 to perform the various functions described below, as well as other protocol processing functions (e.g., data link layer processing).

Machine-readable media may include storage integrated into one or more of the processors. Machine-readable media may also include storage external to the one or more processor, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. In addition, machine-readable media may include a transmission line or a carrier wave that encodes a data signal. Those skilled in the art will recognize how best to implement the described functionality for the processing system.

An example of multiple apparatuses operating in a wireless communications system will now be presented. In one example, the wireless communications system uses a modified version of Common Mode Signaling (CMS) modulation scheme wherein multiple STAs can simultaneously send access probes, thereby eliminating the need for CSMA/CA based directional contention.

Each STA may be allowed to pick an independent Walsh, Golay, or orthogonal CDMA sequence for transmission of an access probe. Each access probe is sent serially across all uplink (UL) transmit beam directions U_{T}, for U_{R} times each, where U_{R} is the number of UL receiver beam directions.

Various MAC protocols for sending access probes and receiving access grants, in response to the access probe, may be used. Access grants are sent by the AP in a unicast fashion, using the optimal downlink (DL) transmit beam. The unicast transmission saves a significant amount of overhead, as the access grant does not have to be sent serially across all DL transmit beam directions. The optimal DL transmit beam direction is obtained from the access probe, which contains this information.

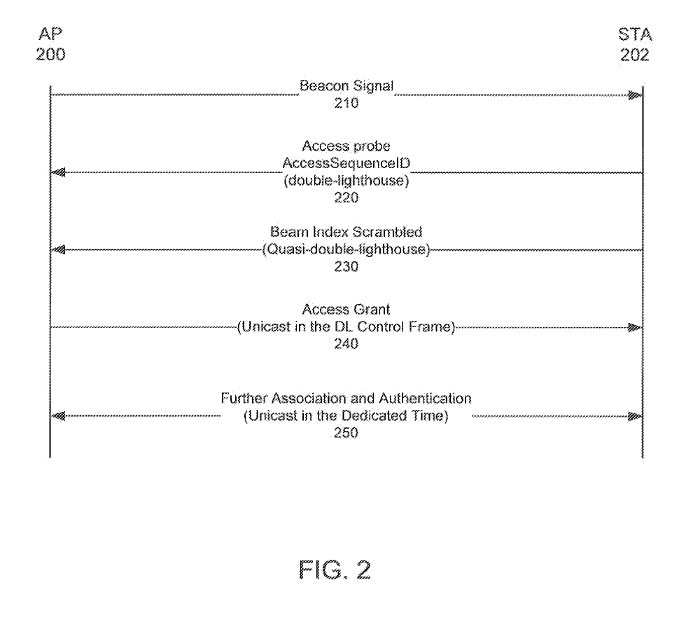

FIG. 2 is a timeline of an exemplary access process. As shown in FIG. 2, using the beacon signal, the STA 202 estimates the DL transmit beam pattern of the AP 200 that is preferred (e.g., the best) for transmitting to the STA 202 and determines the preferred DL receive beam pattern for the STA 202 (step 210). As such, after step 210, the STA 202 knows the preferred DL transmit and receive beam patterns.

The AP reserves Nr Walsh or Golay sequences (of length L each), and a dedicated time-interval for the access probe. A STA 202 that is newly powered on or is transitioning from a sleep state to an active state, performs access as follows:

First, the STA 202 randomly selects one of the Nr allowed Walsh or Golay sequences as its AccessSequenceID and serially transmits the sequence U_{R} times through each of its U_{T} transmit beam patterns (step 220). Hence, a total of U_{T}*U_{R} copies of the Walsh or Golay code will be transmitted. This method of transmission may be referred to as a “double-lighthouse” transmission. If U_{T}=64 and U_{R}=64 (worst case values), the system chip-rate=1.7 Gbps, Walsh chip duration=0.6 ns (assuming a Walsh code is used), Nr=15, and L=64, the total transmission time is approximately 157 us (0.6 ns*64*64*64).

For any given access time, there likely will not be more than two to three access probes. This is because for 60 GHz short-range PAN type networks, there likely will not be more than 16 STAs per AP, and even among these STAs, not all STAs are likely to power up or wake up from sleep at the same time. Wakeup times of STAs can be managed by the AP to reduce collision probability. Furthermore, a random time-backoff spanning a few access times, can also be used to further reduce the probability of collisions during power-up. Finally, power-up collisions are not catastrophic, as the STAs can always try sending the access probe again. With two access probes per access time, the probability of collision equals the probability that two STAs pick the same access sequence, which is 1/15.

The AP 200 receives the sequence sent by the STA 202 and performs a length L Walsh/Golay decoder with threshold detection to determine the access sequence that was sent. Because only Nr sequences are valid sequences, the probability of misdetection or false-alarm is reduced considerably. After step 220, the AP knows the preferred UL transmit and receive beam patterns.

Second, the STA 202 sends an N=6-bit AP transmit beam index to the AP 200. The index indicates a preferred DL transmit beam pattern from the AP 200 to the STA 202 (step 230). Assuming a Walsh sequence is used, the STA 202 selects a length 4*M Walsh sequence corresponding to the 6-bit index, where M=2̂N. The STA 202 scrambles the length 4*M Walsh sequence with a seed, which equals the AccessSequenceID used for sending the access probe. The STA 202 may determine the best beam index by processing the DL beacon and selecting the beam index that maximizes SNR. The scrambling sequence generator can be according to section 12.2.2.10 of the 802.15.3c specification.

As discussed supra, after step 220, the AP knows the preferred UL receive beam pattern directions to use for the STA 202. Assuming that at most Ns STAs will contend during each access, in step 230 the AP can then focus only on the corresponding Ns (or less) beam patterns. Hence, instead of a double-lighthouse transmission, each STAs can transmit only Ns (rather than U_{R}) copies of the Walsh/Golay code through each of the transmit beam patterns U_{T} (quasi-double-lighthouse). Assuming that Ns=16, the total transmission time is approximately 157 us.

The AP 200 then descrambles the received waveform using the AccessSequencelD. The AP 200 then performs a length L Walsh/Golay decoder for the descrambled waveform, to determine the preferred beam index. After step 230, the AP 200 also knows the preferred DL transmit beam pattern.

As explained supra, there likely will not be more than two to three access probes with AccessSequenceIDs sent per access time. Furthermore, the AP 200 does not need to instantiate multiple decoders, as it can process the decoders for different AccessSequenceIDs that have been detected serially.

Third, the AP 200 sends a unicast access grant to each successfully decoded AccessSequenceID in the DL Control Frame (step 240). The unicast message is sent using the preferred DL transmit beam pattern. The unicast grant message may have approximately 32 bits of information, including a StationID, the AccessSequenceID, ranging/power offset information (optional), a beam index corresponding to a preferred UL transmit beam pattern, and a dedicated resource time (in units of ˜1.2 us) for sending UL control information. Accordingly, after step 240, the STA 202 knows the preferred UL transmit beam pattern. The unicast message may be sent using the CMS transmission mode code spreading. In one configuration, the unicast message is sent with an A_{—}64 Golay code sequence with length 64 spreading. When the unicast message has 32 bits of information, the transmission time is approximately 1.2 us (32 bits*64*0.6 ns).

Lastly, because the STA 202 knows the preferred DL transmit and receive beam patterns and the preferred UL transmit beam pattern, and because the AP 200 knows the preferred UL transmit and receive beam patterns and the preferred DL transmit beam pattern, the AP 200 and the STA 202 may then continue the association and authentication using the preferred beam patterns (unicast), possibly according to the 802.11 protocol, during a dedicated time slot (step 250).

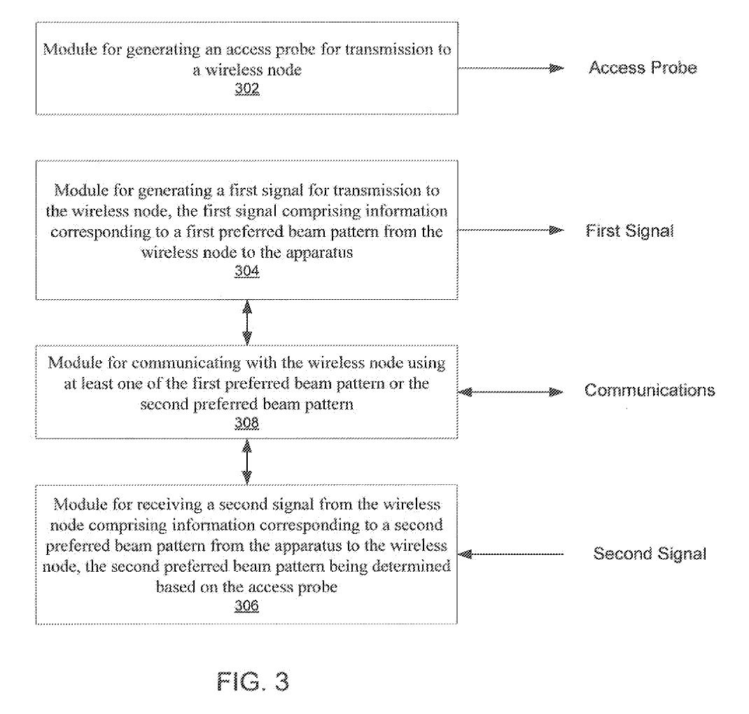

FIG. 3 is a conceptual block diagram illustrating the functionality of an exemplary apparatus. The apparatus 300 may be a STA 202 or other suitable wireless node. The apparatus 300 includes a module 302 for generating an access probe for transmission to a wireless node (e.g., AP 200). The apparatus 300 further includes a module 304 for generating a first signal for transmission to the wireless node. The first signal includes information corresponding to a first preferred beam pattern from the wireless node to the apparatus. The apparatus 300 further includes a module 306 for receiving a second signal from the wireless node including information corresponding to a second preferred beam pattern from the apparatus to the wireless node. The second preferred beam pattern is determined by the wireless node based on the access probe. The apparatus 300 further includes a module 308 for communicating with the wireless node using at least one of the first preferred beam pattern or the second preferred beam pattern. In one configuration, an exemplary apparatus includes a processing system 104 and the processing system 104 is configured to perform the algorithm of the modules 302-308.

In one configuration, the first preferred beam pattern includes a preferred transmit beam pattern of the wireless node and a preferred receive beam pattern of the apparatus. In addition, the first signal includes information corresponding to the preferred transmit beam pattern. If the wireless node is the AP 200 and the apparatus is the STA 202, then the first preferred beam pattern includes a preferred DL transmit beam pattern and a preferred DL receive beam pattern and the first signal includes information corresponding to the preferred DL transmit beam pattern.

In one configuration, the second preferred beam pattern includes a preferred transmit beam pattern of the apparatus and a preferred receive beam pattern of the wireless node. In addition, the second signal includes information corresponding to the preferred transmit beam pattern. If the wireless node is the AP 200 and the apparatus is the STA 202, then the second preferred beam pattern includes a preferred UL transmit beam pattern and a preferred UL receive beam pattern and the second signal includes information corresponding to the preferred UL transmit beam pattern.

In one configuration, the processing system 104 is further configured to determine the first preferred beam pattern. The processing system 104 may be configured to determine the first preferred beam pattern using a beacon signal from the wireless node. The processing system may be configured to support U_{T} different transmit beam patterns and to support the transmission of the access probe sequentially through the U_{T} different transmit beam patterns, U_{R} times through each of the U_{T} different transmit beam patterns, where U_{R} is the number of different receive beam patterns supported by the wireless node (double-lighthouse).

In one configuration, the processing system 104 is configured to support U_{T} different transmit beam patterns and to support transmission of the first signal sequentially through the U_{T} different transmit beam patterns, at least once through each of the U_{T} different transmit beam patterns (quasi-double-lighthouse).

The information corresponding to the first preferred beam pattern may be a wireless node transmit beam index corresponding to a preferred one of different transmit beam patterns from the wireless node.

The access probe may include a first sequence. The processing system 104 may be configured to select the first sequence from a list of sequences provided by the wireless node. In addition, the processing system 104 may be configured to select a sequence from a list of sequences provided by the wireless node and to encode the sequence to generate the first sequence. Furthermore, the processing system 104 may be configured to generate a second sequence corresponding to the wireless node transmit beam index in which the second sequence is different than the first sequence. The processing system 104 may be configured to encode the second sequence with another sequence corresponding to the first sequence for transmission of the wireless node transmit beam index in the first signal using the encoded second sequence. In one configuration, the first and second sequences are either Walsh sequences or Golay sequences.

The processing system 104 may be configured to communicate with the wireless node using code division multiple access communication. The processing system 104 may be configured to communicate with the wireless node, simultaneously as one or more other wireless nodes communicate with the wireless node. The processing system 104 may be configured to communicate with the wireless node across at least one of time, frequency, or code dimensions.

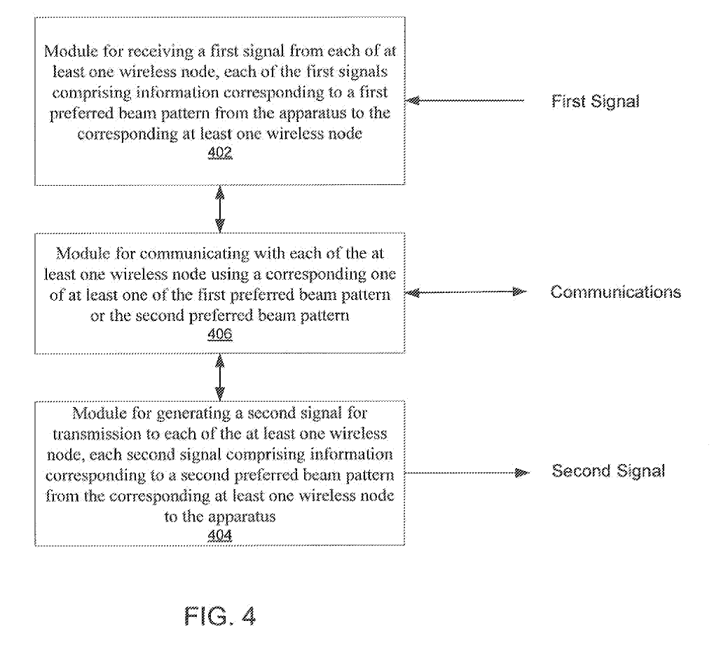

FIG. 4 is a conceptual block diagram illustrating the functionality of another exemplary apparatus. The apparatus 400 may be an AP 200 or other suitable wireless node. The apparatus 400 includes a module 402 for receiving a first signal from each of at least one wireless node. Each first signal includes information corresponding to a first preferred beam pattern from the apparatus to the corresponding at least one wireless node. The apparatus 400 further includes a module 404 for generating a second signal for transmission to each of the at least one wireless node. Each second signal includes information corresponding to a second preferred beam pattern from the corresponding at least one wireless node to the apparatus. The apparatus 400 further includes a module 406 for communicating with each of the at least one wireless node using a corresponding one of at least one of the first preferred beam pattern or the second preferred beam pattern. In one configuration, an exemplary apparatus includes a processing system 104 and the processing system 104 is configured to perform the algorithm of the modules 402-406.

In one configuration, an apparatus for wireless communication (e.g., STA 202) includes means for generating an access probe for transmission to a wireless node; means for generating a first signal for transmission to the wireless node, the first signal including information corresponding to a first preferred beam pattern from the wireless node to the apparatus; means for receiving a second signal from the wireless node including information corresponding to a second preferred beam pattern from the apparatus to the wireless node, the second preferred beam pattern being determined based on the access probe; and means for communicating with the wireless node using at least one of the first preferred beam pattern or the second preferred beam pattern. The aforementioned means is the processing system 104 configured to perform the function associated with the aforementioned means.

In one configuration, an apparatus for wireless communication (e.g., AP 200) includes
means for receiving a first signal from each of at least one wireless node, each first signal including information corresponding to a first preferred beam pattern from the apparatus to the corresponding at least one wireless node; means for generating a second signal for transmission to each of the at least one wireless node, each second signal including information corresponding to a second preferred beam pattern from the corresponding at least one wireless node to the apparatus; and means for communicating with each of the at least one wireless node using a corresponding one of at least one of the first preferred beam pattern or the second preferred beam pattern. The aforementioned means is the processing system 104 configured to perform the function associated with the aforementioned means.

The previous description is provided to enable any person skilled in the art to fully understand the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. A claim that recites at least one of a combination of elements (e.g., “at least one of A, B, or C”) refers to one or more of the recited elements (e.g., A, or B, or C, or any combination thereof). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. An apparatus for wireless communication, comprising:
a processing system configured to:
generate an access probe for transmission to a wireless node;
generate a first signal for transmission to the wireless node, the first signal comprising information corresponding to a first preferred beam pattern from the wireless node to the apparatus;
receive a second signal from the wireless node comprising information corresponding to a second preferred beam pattern from the apparatus to the wireless node, the second preferred beam pattern being determined based on the access probe; and
communicate with the wireless node using at least one of the first preferred beam pattern or the second preferred beam pattern.

2. The apparatus of claim 1, wherein:
the first preferred beam pattern comprises a preferred transmit beam pattern of the wireless node; and
the first signal comprises information corresponding to the preferred transmit beam pattern.

3. The apparatus of claim 1, wherein:
the second preferred beam pattern comprises a preferred transmit beam pattern of the apparatus; and
the second signal comprises information corresponding to the preferred transmit beam pattern.

4. The apparatus of claim 1, wherein the processing system is further configured to determine the first preferred beam pattern.

5. The apparatus of claim 4, wherein the processing system is configured to determine the first preferred beam pattern using a beacon signal from the wireless node.

6. The apparatus of claim 1, wherein the processing system is further configured to:
support U_{T} different transmit beam patterns; and
support the transmission of the access probe sequentially through the U_{T} different transmit beam patterns, U_{R} times through each of the U_{T} different transmit beam patterns, wherein U_{R} is the number of different receive beam patterns supported by the wireless node.

7. The apparatus of claim 1, wherein the processing system is further configured to:
support U_{T} different transmit beam patterns; and
support transmission of the first signal sequentially through the U_{T} different transmit beam patterns, at least once through each of the U_{T} different transmit beam patterns.

8. The apparatus of claim 1, wherein the information corresponding to the first preferred beam pattern is a wireless node transmit beam index corresponding to a preferred one of different transmit beam patterns from the wireless node.

9. The apparatus of claim 8, wherein the access probe comprises a first sequence, and wherein the processing system is configured to generate a second sequence corresponding to the wireless node transmit beam index, the second sequence being different than the first sequence.

10. The apparatus of claim 9, wherein the processing system is configured to encode the second sequence with another sequence corresponding to the first sequence for transmission of the wireless node transmit beam index in the first signal using the encoded second sequence.

11. The apparatus of claim 10, wherein the first sequence comprises a Walsh sequence or a Golay sequence and the second sequence comprises a Walsh sequence or a Golay sequence.

12. The apparatus of claim 1, wherein the processing system is configured to communicate with the wireless node using code division multiple access communication.

13. The apparatus of claim 1, wherein the access probe comprises a first sequence, and wherein the processing system is configured to select the first sequence from a list of sequences provided by the wireless node.

14. The apparatus of claim 1, wherein the access probe comprises a first sequence, and wherein the processing system is configured to select a sequence from a list of sequences provided by the wireless node and to encode the sequence to generate the first sequence.

15. The apparatus of claim 1, wherein the processing system is configured to communicate with the wireless node, simultaneously as one or more other wireless nodes communicate with the wireless node.

16. The apparatus of claim 15, wherein the processing system is further configured to communicate with the wireless node across at least one of time, frequency, or code dimensions.

17. An apparatus for wireless communication, comprising:
a processing system configured to:
receive a first signal from each of at least one wireless node, each first signal comprising information corresponding to a first preferred beam pattern from the apparatus to the corresponding at least one wireless node;
generate a second signal for transmission to each of the at least one wireless node, each second signal comprising information corresponding to a second preferred beam pattern from the corresponding at least one wireless node to the apparatus; and
communicate with each of the at least one wireless node using at least one of the first preferred beam pattern or the second preferred beam pattern corresponding to said each of the at least one wireless node.

18. The apparatus of claim 17, wherein:
the first preferred beam pattern comprises a preferred transmit beam pattern of the apparatus to the corresponding at least one wireless node; and
each first signal comprises information corresponding to the preferred transmit beam pattern of the apparatus to the corresponding at least one wireless node.

19. The apparatus of claim 17, wherein:
the second preferred beam pattern comprises a preferred transmit beam pattern of the corresponding at least one wireless node; and
each of the second signal comprises information corresponding to the preferred transmit beam pattern of the corresponding at least one wireless node to the apparatus.

20. The apparatus of claim 17, wherein the processing system is further configured to:
receive an access probe from each of the at least one wireless node; and
determine the second preferred beam pattern from the corresponding at least one wireless node to the apparatus using the received access probe from each of the at least one wireless node.

21. The apparatus of claim 17, wherein the processing system is further configured to:
support U_{R} different receive beam patterns; and
receive an access probe from one of the at least one wireless node sequentially through the U_{R} different receive beam patterns, U_{T} times through each of the different U_{R} receive beam patterns, wherein U_{T} is the number of different transmit beam patterns supported by said one of the at least one wireless node.

22. The apparatus of claim 17, wherein the processing system is configured to:
support U_{R} different receive beam patterns; and
receive the first signal from one of the at least one wireless node sequentially through the U_{R} different receive beam patterns, at least once through each of the different U_{R} transmit beam patterns.

23. The apparatus of claim 17, wherein the processing system is further configured to support different transmit beam patterns, and the information corresponding to the first preferred beam pattern is a transmit beam index for the apparatus, the transmit beam index corresponding to a preferred one of the different transmit beam patterns for the corresponding at least one wireless node.

24. The apparatus of claim 17, wherein the processing system is further configured to:
receive an access probe from each of the at least one wireless node, each received access probe comprising a distinct first sequence; and
generate a second sequence corresponding to a transmit beam index for each of the at least one wireless node, the generated second sequence being different from the received first sequence for each of the at least one wireless node.

25. The apparatus of claim 24, wherein for each of the at least one wireless node, the processing system is configured to:
encode the second sequence with another sequence corresponding to the distinct first sequence of that wireless node; and
obtain a transmit beam index for that wireless node in the first signal received from that wireless node by using the encoded second sequence.

26. The apparatus of claim 17, wherein the first sequence comprises a Walsh sequence or a Golay sequence and the second sequence comprises a Walsh sequence or a Golay sequence.

27. The apparatus of claim 17, wherein the processing system is configured to communicate with the at least one wireless node using code division multiple access communication.

28. The apparatus of claim 17, wherein the processing system is configured to communicate with more than one of the at least one wireless node simultaneously.

29. The apparatus of claim 28, wherein the processing system is further configured to communicate with the more than one of the at least one wireless node across at least one of time, frequency, or code dimensions.

30. A method for wireless communication, comprising:
generating an access probe for transmission to a wireless node; and
generating a first signal for transmission to the wireless node, the first signal comprising information corresponding to a first preferred beam pattern from the wireless node to an apparatus;
receiving a second signal from the wireless node comprising information corresponding to a second preferred beam pattern from the apparatus to the wireless node, the second preferred beam pattern being determined based on the access probe; and
communicating with the wireless node using at least one of the first preferred beam pattern or the second preferred beam pattern.

31. The method of claim 30, wherein:
the first preferred beam pattern comprises a preferred transmit beam pattern of the wireless node; and
the first signal comprises information corresponding to the preferred transmit beam pattern.

32. The method of claim 30, wherein:
the second preferred beam pattern comprises a preferred transmit beam pattern of the apparatus; and
the second signal comprises information corresponding to the preferred transmit beam pattern.

33. The method of claim 30, further comprising determining the first preferred beam pattern.

34. The method of claim 33, wherein the first preferred beam pattern is determined using a beacon signal from the wireless node.

35. The method of claim 30, further comprising:
supporting U_{T} different transmit beam patterns;
supporting the transmission of the access probe sequentially through the U_{T} different transmit beam patterns, U_{R} times through each of the U_{T} different transmit beam patterns, wherein U_{R} is the number of different receive beam patterns supported by the wireless node.

36. The method of claim 30, further comprising:
supporting U_{T} different transmit beam patterns; and
supporting transmission of the first signal sequentially through the U_{T} different transmit beam patterns, at least once through each of the U_{T} different transmit beam patterns.

37. The method of claim 30, wherein the information corresponding to the first preferred beam pattern is a wireless node transmit beam index corresponding to a preferred one of different transmit beam patterns from the wireless node.

38. The method of claim 37, wherein the access probe comprises a first sequence, the method further comprising generating a second sequence corresponding to the wireless node transmit beam index, the second sequence being different than the first sequence.

39. The method of claim 38, further comprising encoding the second sequence with another sequence corresponding to the first sequence for transmission of the wireless node transmit beam index in the first signal using the encoded second sequence.

40. The method of claim 39, wherein the first sequence comprises a Walsh sequence or a Golay sequence and the second sequence comprises a Walsh sequence or a Golay sequence.

41. The method of claim 30, wherein the communications with the wireless node is performed using code division multiple access.

42. The method of claim 30, wherein the access probe comprises a first sequence, the method further comprising selecting the first sequence from a list of sequences provided by the wireless node.

43. The method of claim 30, wherein the access probe comprises a first sequence, the method further comprising selecting a sequence from a list of sequences provided by the wireless node and to encode the sequence to generate the first sequence.

44. The method of claim 30, wherein the communication with the wireless node is performed, simultaneously as one or more other wireless nodes communicate with the wireless node.

45. The method of claim 44, wherein the communication with the wireless node is across at least one of time, frequency, or code dimensions.

46. A method for wireless communication, comprising:
receiving a first signal from each of at least one wireless node, each first signal comprising information corresponding to a first preferred beam pattern from an apparatus to the corresponding at least one wireless node;
generating a second signal for transmission to each of the at least one wireless node, each second signal comprising information corresponding to a second preferred beam pattern from the corresponding at least one wireless node to the apparatus; and
communicating with each of the at least one wireless node using at least one of the first preferred beam pattern or the second preferred beam pattern corresponding to said each of the at least one wireless node.

47. The method of claim 46, wherein:
the first preferred beam pattern comprises a preferred transmit beam pattern of the apparatus to the corresponding at least one wireless node; and
each first signal comprises information corresponding to the preferred transmit beam pattern of the apparatus to the corresponding at least one wireless node.

48. The method of claim 46, wherein:
the second preferred beam pattern comprises a preferred transmit beam pattern of the corresponding at least one wireless node; and
each of the second signal comprises information corresponding to the preferred transmit beam pattern of the corresponding at least one wireless node to the apparatus.

49. The method of claim 46, further comprising:
receiving an access probe from each of the at least one wireless node; and
determining the second preferred beam pattern from the corresponding at least one wireless node to the apparatus using the received access probe from each of the at least one wireless node.

50. The method of claim 46, further comprising:
supporting U_{R} different receive beam patterns; and
receiving an access probe from one of the at least one wireless node sequentially through the U_{R} different receive beam patterns, U_{T} times through each of the different U_{R} receive beam patterns, wherein U_{T} is the number of different transmit beam patterns supported by said one of the at least one wireless node.

51. The method of claim 46, further comprising:
supporting U_{R} different receive beam patterns; and
receiving the first signal from one of the at least one wireless node sequentially through the U_{R} different receive beam patterns, at least once through each of the different U_{R} transmit beam patterns.

52. The method of claim 46, further comprising supporting different transmit beam patterns, and the information corresponding to the first preferred beam pattern is a transmit beam index for the apparatus, the transmit beam index corresponding to a preferred one of the different transmit beam patterns for the corresponding at least one wireless node.

53. The method of claim 46, further comprising:
receiving an access probe from each of the at least one wireless node, each received access probe comprising a distinct first sequence; and
generating a second sequence corresponding to a transmit beam index for each of the at least one wireless node, the generated second sequence being different from the received first sequence for each of the at least one wireless node.

54. The method of claim 53, wherein for each of the at least one wireless node, the method further comprises:
encoding the second sequence with another sequence corresponding to the distinct first sequence of that wireless node; and
obtaining a transmit beam index for that wireless node in the first signal received from that wireless node by using the encoded second sequence.

55. The method of claim 46, wherein the first sequence comprises a Walsh sequence or a Golay sequence and the second sequence comprises a Walsh sequence or a Golay sequence.

56. The method of claim 46, wherein the communications with the at least one wireless node are performed using code division multiple access.

57. The method of claim 46, wherein the communications with more than one of the at least one wireless node are performed simultaneously.

58. The method of claim 57, wherein the communication with the more than one of the at least one wireless node are performed across at least one of time, frequency, or code dimensions.

59. An apparatus for wireless communication, comprising:
means for generating an access probe for transmission to a wireless node;
means for generating a first signal for transmission to the wireless node, the first signal comprising information corresponding to a first preferred beam pattern from the wireless node to the apparatus;
means for receiving a second signal from the wireless node comprising information corresponding to a second preferred beam pattern from the apparatus to the wireless node, the second preferred beam pattern being determined based on the access probe; and
means for communicating with the wireless node using at least one of the first preferred beam pattern or the second preferred beam pattern.

60. The apparatus of claim 59, wherein:
the first preferred beam pattern comprises a preferred transmit beam pattern of the wireless node; and
the first signal comprises information corresponding to the preferred transmit beam pattern.

61. The apparatus of claim 59, wherein:
the second preferred beam pattern comprises a preferred transmit beam pattern of the apparatus; and
the second signal comprises information corresponding to the preferred transmit beam pattern.

62. The apparatus of claim 59, further comprising means for determining the first preferred beam pattern.

63. The apparatus of claim 62, wherein the first preferred beam pattern is determined using a beacon signal from the wireless node.

64. The apparatus of claim 59, further comprising:
means for supporting U_{T} different transmit beam patterns; and
means for supporting the transmission of the access probe sequentially through the U_{T} different transmit beam patterns, U_{R} times through each of the U_{T} different transmit beam patterns, wherein U_{R} is the number of different receive beam patterns supported by the wireless node.

65. The apparatus of claim 59, further comprising:
means for supporting U_{T} different transmit beam patterns; and
means for supporting transmission of the first signal sequentially through the U_{T} different transmit beam patterns, at least once through each of the U_{T} different transmit beam patterns.

66. The apparatus of claim 59, wherein the information corresponding to the first preferred beam pattern is a wireless node transmit beam index corresponding to a preferred one of different transmit beam patterns from the wireless node.

67. The apparatus of claim 66, wherein the access probe comprises a first sequence, the method further comprising means for generating a second sequence corresponding to the wireless node transmit beam index, the second sequence being different than the first sequence.

68. The apparatus of claim 67, further comprising means for encoding the second sequence with another sequence corresponding to the first sequence for transmission of the wireless node transmit beam index in the first signal using the encoded second sequence.

69. The apparatus of claim 68, wherein the first sequence comprises a Walsh sequence or a Golay sequence and the second sequence comprises a Walsh sequence or a Golay sequence.

70. The apparatus of claim 59, wherein the communications with the wireless node is performed using code division multiple access.

71. The apparatus of claim 59, wherein the access probe comprises a first sequence, the method further comprising means for selecting the first sequence from a list of sequences provided by the wireless node.

72. The apparatus of claim 59, wherein the access probe comprises a first sequence, the method further comprising means for selecting a sequence from a list of sequences provided by the wireless node and to encode the sequence to generate the first sequence.

73. The apparatus of claim 59, wherein the communication with the wireless node is performed, simultaneously as one or more other wireless nodes communicate with the wireless node.

74. The apparatus of claim 73, wherein the communication with the wireless node is across at least one of time, frequency, or code dimensions.

75. An apparatus for wireless communication, comprising:
means for receiving a first signal from each of at least one wireless node, each first signal comprising information corresponding to a first preferred beam pattern from the apparatus to the corresponding at least one wireless node;
means for generating a second signal for transmission to each of the at least one wireless node, each second signal comprising information corresponding to a second preferred beam pattern from the corresponding at least one wireless node to the apparatus; and
means for communicating with each of the at least one wireless node using at least one of the first preferred beam pattern or the second preferred beam pattern corresponding to said each of the at least one wireless node.

76. The apparatus of claim 75, wherein:
the first preferred beam pattern comprises a preferred transmit beam pattern of the apparatus to the corresponding at least one wireless node; and
each first signal comprises information corresponding to the preferred transmit beam pattern of the apparatus to the corresponding at least one wireless node.

77. The apparatus of claim 75, wherein:
the second preferred beam pattern comprises a preferred transmit beam pattern of the corresponding at least one wireless node; and
each of the second signal comprises information corresponding to the preferred transmit beam pattern of the corresponding at least one wireless node to the apparatus.

78. The apparatus of claim 75, further comprising:
means for receiving an access probe from each of the at least one wireless node; and
means for determining the second preferred beam pattern from the corresponding at least one wireless node to the apparatus using the received access probe from each of the at least one wireless node.

79. The apparatus of claim 75, further comprising:
means for supporting U_{R} different receive beam patterns; and
means for receiving an access probe from one of the at least one wireless node sequentially through the U_{R} different receive beam patterns, U_{T} times through each of the different U_{R} receive beam patterns, wherein U_{T} is the number of different transmit beam patterns supported by said one of the at least one wireless node.

80. The apparatus of claim 75, further comprising:
means for supporting U_{R} different receive beam patterns; and
means for receiving the first signal from one of the at least one wireless node sequentially through the U_{R} different receive beam patterns, at least once through each of the different U_{R} transmit beam patterns.

81. The apparatus of claim 75, further comprising means for supporting different transmit beam patterns, and the information corresponding to the first preferred beam pattern is a transmit beam index for the apparatus, the transmit beam index corresponding to a preferred one of the different transmit beam patterns for the corresponding at least one wireless node.

82. The apparatus of claim 75, further comprising:
means for receiving an access probe from each of the at least one wireless node, each received access probe comprising a distinct first sequence; and
means for generating a second sequence corresponding to a transmit beam index for each of the at least one wireless node, the generated second sequence being different from the received first sequence for each of the at least one wireless node.

83. The apparatus of claim 82, wherein for each of the at least one wireless node, the method further comprises:
means for encoding the second sequence with another sequence corresponding to the distinct first sequence of that wireless node; and
means for obtaining a transmit beam index for that wireless node in the first signal received from that wireless node by using the encoded second sequence.

84. The apparatus of claim 75, wherein the first sequence comprises a Walsh sequence or a Golay sequence and the second sequence comprises a Walsh sequence or a Golay sequence.

85. The apparatus of claim 75, wherein the communications with the at least one wireless node are performed using code division multiple access.

86. The apparatus of claim 75, wherein the communications with more than one of the at least one wireless node are performed simultaneously.

87. The apparatus of claim 86, wherein the communication with the more than one of the at least one wireless node are performed across at least one of time, frequency, or code dimensions.

88. A computer-program product for communication, comprising:
a machine-readable medium comprising instructions executable to:
generate an access probe for transmission to a wireless node;
generate a first signal for transmission to the wireless node, the first signal comprising information corresponding to a first preferred beam pattern from the wireless node to the apparatus;
receive a second signal from the wireless node comprising information corresponding to a second preferred beam pattern from the apparatus to the wireless node, the second preferred beam pattern being determined based on the access probe; and
communicate with the wireless node using at least one of the first preferred beam pattern or the second preferred beam pattern.

89. A computer-program product for communication, comprising:
a machine-readable medium comprising instructions executable to:
receive a first signal from each of at least one wireless node, each first signal comprising information corresponding to a first preferred beam pattern from the apparatus to the corresponding at least one wireless node;
generate a second signal for transmission to each of the at least one wireless node, each second signal comprising information corresponding to a second preferred beam pattern from the corresponding at least one wireless node to the apparatus; and
communicate with each of the at least one wireless node using at least one of the first preferred beam pattern or the second preferred beam pattern corresponding to said each of the at least one wireless node.

90. A station for wireless communication, comprising:
a processing system configured to:
generate an access probe for transmission to a wireless node;
generate a first signal for transmission to the wireless node, the first signal comprising information corresponding to a first preferred beam pattern from the wireless node to the station;
receive a second signal from the wireless node comprising information corresponding to a second preferred beam pattern from the station to the wireless node, the second preferred beam pattern being determined based on the access probe; and
communicate with the wireless node using at least one of the first preferred beam pattern or the second preferred beam pattern;
a wireless interface having one or more antennas configured to support the first and second preferred beam patterns; and
a user interface coupled to the processing system.

91. An access point, comprising:
a processing system configured to:
receive a first signal from each of at least one wireless node, each first signal comprising information corresponding to a first preferred beam pattern from the access point to the corresponding at least one wireless node;
generate a second signal for transmission to each of the at least one wireless node, each second signal comprising information corresponding to a second preferred beam pattern from the corresponding at least one wireless node to the access point; and
communicate with each of the at least one wireless node using at least one of the first preferred beam pattern or the second preferred beam pattern corresponding to said each of the at least one wireless node;
a wireless interface having one or more antennas configured to support the first and second preferred beam patterns.
